(19) United States
(12) Patent Application Publication
(10) Pub. No.: US 2026/0065414 A1
(43) Pub. Date: Mar. 5, 2026

(54) IMAGE PROCESSING METHOD AND DEVICE

(71) Applicant: Lenovo (Beijing) Limited, Beijing (CN)

(72) Inventor: Shuangxin YANG, Beijing (CN)

(21) Appl. No.: 19/313,199

(22) Filed: Aug. 28, 2025

(30) Foreign Application Priority Data
Aug. 28, 2024 (CN) 202411196582.5

(51) Int. Cl. G06T 3/40

(52) U.S. Cl. CPC G06T 3/40

(57) ABSTRACT

An image processing method includes: obtaining a target image and a reference image, the target image having a smaller field of view than the reference image; and using a target model to generate a display image from the reference image and the target image, where the display image includes image content of the reference image and is larger than the target image.

### RELATED APPLICATION(S)

This application claims priority to Chinese Patent Application No. 2024111965825 filed with China Intellectual Property Administration, on Aug. 28, 2024, which is incorporated herein by reference in entirety.

### FIELD OF THE TECHNOLOGY

The present disclosure relates to a field of image processing technology, and in particular to an image processing method and device.

### BACKGROUND

Certain existing technical solutions for image expansion may use generative artificial intelligence to process the images that need to be expanded. However, the expanded content of the generated expanded images is not necessarily in line with common sense in reality.

### SUMMARY

In one aspect, the present disclosure provides an image processing method. The method includes: obtaining a target image and a reference image, the target image having a smaller field of view than the reference image; and using a target model to generate a display image from the reference image and the target image, wherein the display image includes image content of the reference image and is larger than the target image

In another aspect, the present disclosure provides an electronic device. The device includes: a memory storing computer program instructions; and a processor coupled to the memory and configured to execute the computer program instructions and perform: obtaining a target image and a reference image, the target image having a smaller field of view than the reference image; and using a target model to generate a display image from the reference image and the target image, wherein the display image includes image content of the reference image and is larger than the target image.

In yet another aspect, the present disclosure provides a non-transitory computer-readable storage medium storing computer program instructions executable by at least one processor to perform: obtaining a target image and a reference image, the target image having a smaller field of view than the reference image; and using a target model to generate a display image from the reference image and the target image, wherein the display image includes image content of the reference image and is larger than the target image.

### BRIEF DESCRIPTION OF THE DRAWINGS

The drawings described below are incorporated into and constitute a part of the present disclosure. These drawings are used to illustrate the technical solutions of the present disclosure.

FIG. 1 is a schematic diagram of an implementation flow of an image processing method according to certain embodiments of the present disclosure;

FIG. 2 is a schematic diagram of an implementation flow of an image processing method according to certain embodiments of the present disclosure;

FIG. 3 is a schematic diagram of an implementation flow of an image processing method according to certain embodiments of the present disclosure;

FIG. 4A is a schematic diagram of an implementation flow of an image processing method according to certain embodiments of the present disclosure;

FIG. 4B is a schematic diagram of an implementation flow of an image processing method according to certain embodiments of the present disclosure;

FIG. 5 is a schematic diagram of an implementation flow of an image processing method according to certain embodiments of the present disclosure;

FIG. 6 is a schematic diagram of an implementation flow of an image processing method according to certain embodiments of the present disclosure;

FIG. 7 is a schematic diagram of an implementation flow of an image processing method according to certain embodiments of the present disclosure;

FIG. 8 is a schematic diagram of an implementation flow of an image processing method according to certain embodiments of the present disclosure;

FIG. 9 is a schematic diagram of an implementation flow of an image processing method according to certain embodiments of the present disclosure;

FIG. 10 is a schematic diagram of an implementation flow of an image processing method according to certain embodiments of the present disclosure;

FIG. 11 is a schematic diagram of the implementation flow of an image processing method according to certain embodiments of the present disclosure;

FIG. 12 is a schematic diagram of the implementation flow of an image expansion method according to certain embodiments of the present disclosure;

FIG. 13 is a schematic diagram of an implementation process of an image expansion method according to certain embodiments of the present disclosure;

FIG. 14 is a schematic diagram of an implementation of wide-angle image storage according to certain embodiments of the present disclosure;

FIG. 15 is a schematic diagram of an implementation flow of a method for expanding an image according to certain embodiments of the present disclosure;

FIG. 16A is a schematic diagram of an implementation of a photographing principle according to certain embodiments of the present disclosure;

FIG. 16B is a schematic diagram of an implementation flow of a method for expanding an image according to certain embodiments of the present disclosure;

FIG. 17 is a schematic diagram of an implementation flow of a method for expanding an image according to certain embodiments of the present disclosure;

FIG. 18A is a schematic diagram of an implementation of a photographing end architecture according to certain embodiments of the present disclosure;

FIG. 18B is a schematic diagram of an implementation of an expanded image according to certain embodiments of the present disclosure;

FIG. 19 is a schematic diagram of an implementation flow of a method for expanding an image according to certain embodiments of the present disclosure;

FIG. 20 is a schematic diagram of an implementation flow of a method for expanding an image according to certain embodiments of the present disclosure;

FIG. 21 is a schematic diagram of the structure of an image processing device according to certain embodiments of the present disclosure;

FIG. 22 is a schematic diagram of the structure of an image processing device according to certain embodiments of the present disclosure;

FIG. 23 is a schematic diagram of the hardware components of an electronic device according to certain embodiments of the present disclosure; and

FIG. 24 is a schematic diagram of the hardware components of an electronic device according to certain embodiments of the present disclosure.

### DETAILED DESCRIPTION

To state the objectives, technical solutions, and advantages of the present disclosure, the technical solutions of the present disclosure are described below with reference to the accompanying drawings and embodiments. The embodiments described should not be construed as necessarily limiting the present disclosure. Other embodiments devised by persons of ordinary skill in the technical field without inventive effort are within the scope of protection of the present disclosure.

In the following description, references to “certain embodiments” describe a subset of all possible embodiments. However, “certain embodiments” may be the same subset or different subsets of all possible embodiments, and may be combined with each other where no conflict exists. The terms “first/second/third” are used to distinguish similar objects and do not necessarily represent a particular ordering of the objects. Terms “first/second/third” may be interchanged in a particular order or sequential order, so that certain embodiments may be implemented in an order other than that illustrated or described herein.

In certain embodiments, technical and scientific terms used herein have the same meaning as understood by persons skilled in the technical field. The terminology used herein is for descriptive purposes only and is not intended to limit the scope of the present disclosure.

Certain existing technical solutions for image expansion utilize generative artificial intelligence to process the image to be expanded. However, the expanded content of the generated expanded image may not conform to common sense, resulting in low accuracy in image expansion.

Certain embodiments of the present disclosure provide an image processing method. Because the reference image and the target image have the same shooting orientation and location, it may be determined that the image content in the reference image and the target image have the same perspective and scene. Furthermore, because the reference image's field of view is greater than that of the target image, it may be determined that the visual range of the image content in the reference image is greater than that of the target image. By expanding the image content in the target image based on the content in the reference image, a display image may be obtained, improving the accuracy of image expansion.

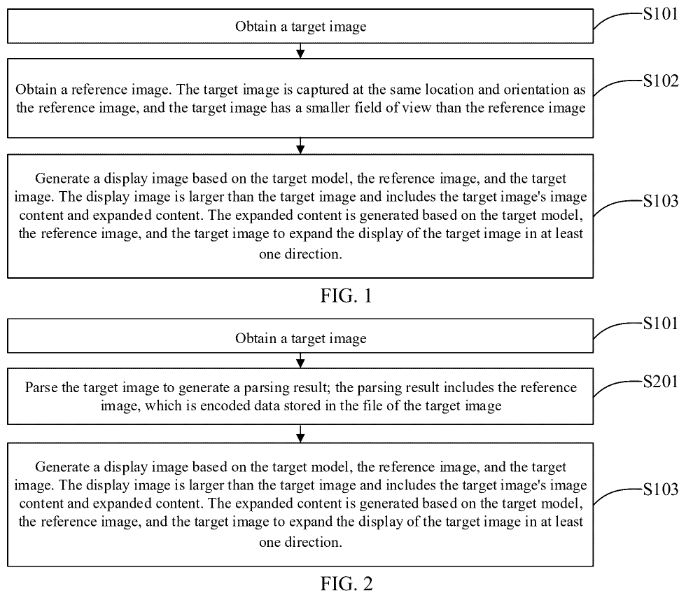

FIG. 1 is a schematic diagram illustrating the implementation flow of an image processing method according to certain embodiments of the present disclosure. As shown in FIG. 1, the method includes the following steps S101 to S103, which are described in conjunction with the steps shown in FIG. 1.

Step S101: Obtain a target image.

In certain embodiments, the target image represents an image to be expanded. In response to an expansion operation on the target image, the target image is obtained.

In certain embodiments, obtaining the target image may be achieved by capturing the image using any camera, capturing the image from a captured and saved image, or the like.

For example, the target image may be captured using a mobile phone or camera, or obtained from a mobile phone's photo album or a camera's memory card.

Step S102: Obtain a reference image. The target image is captured at the same location and orientation as the reference image, and the target image has a smaller field of view than the reference image.

In certain embodiments, the reference image is used to expand the target image based on content in the reference image that is not present in the target image when performing an expansion operation on the target image.

For example, when the target image includes 60% of object A and the reference image includes 100% of object A, the target image is expanded based on the remaining portion of object A in the reference image excluding the 60% portion of object A in the target image to obtain an expanded image. The extended image has the same viewing angle as the target image, and the completeness of object A in the extended image is greater than the completeness of object A in the target image.

In certain embodiments, obtaining the reference image may be achieved by capturing it with any camera, obtaining it from a saved image, or the like.

In certain embodiments, the reference image may be stored in the header file of the target image. In response to a command to expand the target image, the reference image may be obtained by parsing the header file of the target image.

In certain embodiments, the reference image and the target image are associated with each other. In response to a command to expand the target image, the reference image is obtained from a saved image based on the association between the reference image and the target image.

In certain embodiments, the target image is captured at the same location as the reference image. The location of the camera used to capture the target image is the same as the location of the camera used to capture the reference image. In certain embodiments, the target image is obtained by photographing a target object at point A using a camera; a reference image is obtained by photographing the target object at point A using the same camera.

In certain embodiments, the target image is taken in the same direction as the reference image. When photographing the target object to obtain the target image and the reference image using the camera, the camera's lens has the same shooting angle relative to the target object. The target image is obtained by photographing the target object from a 30-degree upward angle, directly east of the target object. The reference image is obtained by photographing the target object from a 30-degree upward angle, directly east of the target object.

In certain embodiments, the field of view of the target image is smaller than the field of view of the reference image. The focal length of the lens of the camera used to photograph the target image is larger than the focal length of the lens of the camera used to photograph the reference image. This represents that the field of view of the target image is smaller than the field of view of the reference image.

In certain embodiments, the target image and the reference image may be captured by the same camera or different cameras. When the target image and the reference image are captured by the same camera, the target image may be captured using the device's main camera lens or telephoto lens, and the reference image may be captured using the device's wide-angle lens. The reference image captured using the wide-angle lens has a larger field of view than the target image captured using the main camera lens or telephoto lens.

Step S103: Generate a display image based on the target model, the reference image, and the target image.

The display image is larger than the target image and includes the target image's image content and expanded content. The expanded content is generated based on the target model, the reference image, and the target image to expand the display of the target image in at least one direction. In certain embodiments, the target model is a trained image expansion model. In certain embodiments, the trained image expansion model may be trained by: obtaining multiple training samples; each training sample includes a first sample image and a second sample image, and a label image corresponding to the training sample; inputting the first sample image and the second sample image into the image expansion model to be trained to obtain a predicted image; adjusting the model parameters of the image expansion model to be trained based on the loss between the predicted image and the label image until convergence conditions are met, and outputting the trained image expansion model.

In certain embodiments, the target model may include a Generative Adversarial Network (GAN) model, a Pixel Recurrent Neural Network (PRNN) model, or the like.

In certain embodiments, a display image is generated based on the target model, the reference image, and the target image. The target image and the reference image are input into the trained image expansion model to obtain the display image.

In certain embodiments, the display image includes the image content of the target image and the expanded content. The completeness of the target content contained in the display image is greater than the completeness of the target content in the target image; for example, the target image contains 60% of the target object; the display image contains 80% of the target object, of which 20% of the target objects contained in the display image are expanded content. In certain embodiments, the number or type of target content contained in the display image is greater than the number or type of target content contained in the target image; for example, the display image contains two trees and one person; the target image contains one tree, where, except for the one tree in the target image, the remaining tree and person in the display image are expanded content.

In certain embodiments, expanding the target image in at least one direction may include expanding the target image to the left, expanding the target image to the right, expanding the target image upward, expanding the target image downward, and so on.

In certain embodiments, the expansion of the displayed content in at least one direction of the target image is determined based on an expansion parameters for the target image. For example, when the expansion parameters for the target image is to expand the target image by 30% to the left and 40% to the right, the target image, the reference image, and the expansion parameters to expand the target image by 30% to the left and 40% to the right are input into the trained image expansion model to generate a display image expanded by 30% to the left and 40% to the right. The content of the display image that is expanded by 30% to the left and 40% to the right compared to the target image represents the expanded content in accordance with certain embodiments of the present disclosure.

In certain embodiments, the resolution of the display image is the same as that of the target image. Therefore, after expanding the display image in at least one direction, while the resolution remains unchanged, the size of the expanded display image increases. The size corresponding to the expanded content is increased.

In certain embodiments of the present disclosure, the reference image's shooting direction and shooting position are identical to those of the target image, the image content in the reference image and the target image have the same perspective and scene. The reference image's field of view is greater than that of the target image, the visual range of the image content in the reference image is greater than the visual range of the target image. By expanding the image content in the target image based on the image content in the reference image, the display image may be obtained, improving the accuracy of the image expansion.

In certain embodiments, the term “same” or “identical” refers to a value comparison that allows an increase or decrease within a reasonable range. For example, the location of camera that captures the target image is location L1, the location of camera that captures the reference image is L2, in embodiments where the location of camera that captures the target image is considered same or identical to the location of camera that captures the reference image, a difference between L1 and L2 is zero or zero plus or minus an error of up to 10 percent, 5 percent, or 1 percent of L1, or 10 percent, 5 percent, or 1 percent of L2. For example, the shooting angle of camera that captures the target image is angle A1, the shooting angle of camera that captures the reference image is A2, in embodiments where the shooting angle of camera that captures the target image is considered same or identical to the shooting angle of camera that captures the reference image, a difference between A1 and A2 is zero or zero plus or minus an error of up to 10 percent, 5 percent, or 1 percent of A1, or 10 percent, 5 percent, or 1 percent of A2.

FIG. 2 is a schematic flow diagram of an implementation of an image processing method according to certain embodiments of the present disclosure. Based on FIG. 1, step S102 in FIG. 1 may be updated to step S201, which is described in conjunction with the steps shown in FIG. 2.

Step S201: Parse the target image to generate a parsing result; the parsing result includes the reference image, which is encoded data stored in the file of the target image.

In certain embodiments of the present disclosure, the reference image is the encoded data stored in the target image. When the reference image and the target image are captured by a camera, the reference image is encoded to obtain the encoded data of the reference image, and the encoded data of the reference image is stored in the header file of the target image. In certain embodiments, the reference image in picture format may be stored in the header file of the target image. Storing the encoded data of the reference image in the header file of the target image occupies less space than storing the reference image in picture format in the header file of the target image.

In certain embodiments, encoded data including a reference image may be obtained by: parsing the header file of the target image to obtain a parsing result including the encoded data of the reference image; parsing the header file of the target image to obtain a parsing result including the reference image, encoding the reference image to obtain the encoded data of the reference image.

In certain embodiments, the encoding method for encoding the reference image may include lossless compression, lossy compression, latent space coding, or the like, where the memory occupied by the encoded data after encoding the reference image is less than the memory occupied before encoding. For example, when the reference image is encoded using lossless compression, Run-Length Encoding (RLE) and Huffman Coding may be used to compress the reference image data, resulting in a Portable Network Graphics (PNG) encoded data. When the reference image is encoded using latent space coding, the encoded data is a latent space representation.

In certain embodiments of the present disclosure, the reference image is encoded using latent space coding to obtain the latent space representation of the reference image. In certain embodiments of the present disclosure, the reference image is stored in the file of the target image in the format of encoded data to reduce the memory occupied by the reference image. By parsing the header file of the target image, the encoded data of the reference image is obtained to improve the data computing efficiency during the expansion process of the target image.

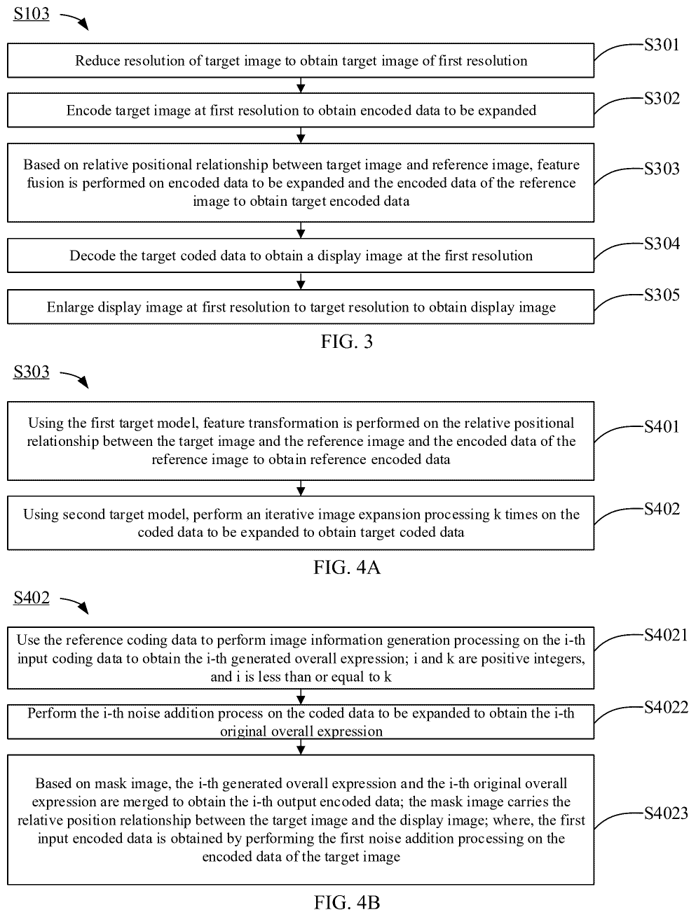

FIG. 3 is a schematic diagram of the implementation flow of an image processing method according to certain embodiments of the present disclosure. The analysis result also includes the relative positional relationship between the target image and the reference image. Based on FIG. 1, step S103 in FIG. 1 may be updated to steps S301 through S305, which is described in conjunction with the steps shown in FIG. 3.

Step S301: Reduce the resolution of the target image to obtain a target image of a first resolution.

In certain embodiments, the resolution of the target image may be represented by the number of pixels in a first direction and the number of pixels in a second direction.

In certain embodiments, the number of pixels in the first direction of the target image is reduced from the first number of pixels to the first number of pixels, and the number of pixels in the second direction of the target image is reduced from the third number of pixels to the fourth number of pixels, to obtain the target image of the first resolution; where the first number of pixels is greater than or equal to the second number of pixels, and the third number of pixels is greater than or equal to the fourth number of pixels. For example, the target image resolution is 1920*1080. The number of pixels in the horizontal direction of the target image is reduced from 1920 to 512; the number of pixels in the vertical direction of the target image is reduced from 1080 to 1080, and the target image with a resolution of 512*1080 is obtained.

Step S302: Encode the target image at the first resolution to obtain the encoded data to be expanded.

In certain embodiments, the target image at the first resolution is encoded to obtain the encoded data to be expanded. Latent space encoding is performed on the target image at the first resolution to obtain the latent space code to be expanded. For example, latent space encoding is performed on the target image with a resolution of 512*512 to obtain the latent space code to be expanded.

Step S303: Based on the relative positional relationship between the target image and the reference image, feature fusion is performed on the encoded data to be expanded and the encoded data of the reference image to obtain target encoded data using the target model.

In certain embodiments, the relative positional relationship between the target image and the reference image represents the relationship between the coordinates of key points in the target image and key points in the reference image. For example, the relative positional relationship between the target image and the reference image may be the relationship between the coordinates of a person in the target image and the coordinates of a task in the reference image.

In certain embodiments, the target model performs feature fusion on the coded data to be expanded and the coded data of the reference image based on the relative positional relationship between the target image and the reference image to obtain target coded data. The target model aligns the coordinates of key points in the target image and the reference image based on the relative positional relationship between the target image and the reference image, and performs feature fusion on the aligned coded data of the reference image and the coded data to be expanded to obtain target coded data.

In certain embodiments, the target model aligns the coordinates of information such as people and objects in the target image and the reference image based on the relative positional relationship between the target image and the reference image, and performs feature fusion on the latent space representation of the aligned reference image and the latent space representation to be expanded to obtain the target latent space representation.

Step S304: Decode the target coded data to obtain a display image at the first resolution.

In certain embodiments, the target coded data is decoded to obtain a display image at the first resolution. The target coded data is subjected to latent space decoding to obtain the display image at the first resolution. For example, the target coded data is subjected to latent space decoding to obtain a display image with a resolution of 512*512.

Step S305: Enlarge the display image at the first resolution to the target resolution to obtain the display image.

In certain embodiments, the display image at the first resolution is enlarged to the target resolution to obtain the display image. The display image is enlarged by enlarging the horizontal pixel count of the display image at the first resolution to the target pixel count and by enlarging the vertical pixel count of the display image at the first resolution to the target pixel count.

For example, a 512*512 resolution display image is super-resolved using super-resolution technology to upscale the horizontal pixels of the 512*512 resolution display image to 1920, and upscale the vertical pixels of the 512*512 resolution display image to 1080, resulting in a 1920*1080 resolution display image.

In certain embodiments of the present disclosure, the resolution of the target image is reduced to a first resolution to reduce memory usage, thereby improving the efficiency of post-decoding and encoding. A target model, based on the target model and the relative positional relationship between the target image and the reference image, performs feature fusion on the coded data to be upscaled and the coded data of the reference image to obtain target coded data. A display image of the first resolution is obtained based on the target coded data, and the display image of the first resolution is upscaled to the target resolution, thereby improving the clarity and accuracy of the display image.

FIG. 4A is a schematic diagram illustrating the implementation flow of an image processing method according to certain embodiments of the present disclosure. In view of FIG. 3, the target model includes a first target model and a second target model. Step S303 in FIG. 3 may be updated to steps S401 and S402, which is described in conjunction with the steps shown in FIG. 4A.

Step S401: Using the first target model, feature transformation is performed on the relative positional relationship between the target image and the reference image and the encoded data of the reference image to obtain reference encoded data. The reference encoded data carries image features of each position in the reference image from the perspective of the target image.

In certain embodiments, the encoded data of the reference image representing the relative positional relationship between the target image and the reference image is input into the first target model. The target image features of the target person or object in the reference image are obtained from the encoded data of the reference image. The reference encoded data is generated based on the relationship between the reference image and the target image and the target image features. The reference encoded data represents the image features present at each position in the reference image from the perspective of the target image.

In certain embodiments, the first target model may be a decoupled cross-attention model, which, based on a decoupled cross-attention mechanism, separates the cross-attention layers for text features and image features, enabling image cues and text features to work together. In certain embodiments of the present disclosure, text features may be the coordinate relationship between the target image and the target object in the reference image; image features may be the encoded data of the reference image.

In certain embodiments, the coordinate relationship between the target image and the target object in the reference image and the latent space representation of the reference image are input into the decoupled cross-attention model. The decoupled cross-attention model obtains target image features in the reference image based on the latent space representation of the reference image, and generates the reference latent space representation based on the coordinate relationship between the target image and the target object or person in the reference image. The reference latent space representation contains the image features of the target person or object in the reference image from the perspective of the target image.

Step S402: Using the second target model, perform an iterative image expansion processing k times on the coded data to be expanded based on the reference coded data to obtain the target coded data.

In certain embodiments, the second target model may be an iterative model, configured to perform denoising and de-noising on data B N times based on the characteristics of data A to obtain the target coded data.

In certain embodiments, using the second target model, the image expansion process is performed k times on the coded data to be expanded based on the characteristics of each position in the reference coded data and the coordinate relationship of the target person or object to obtain the target coded data. The denoising and de-noising process is performed k times on the coded data to be expanded based on the characteristics of each position in the reference coded data and the coordinate relationship of the target person or object to obtain the target coded data.

In certain embodiments, FIG. 4B is a schematic flowchart illustrating an implementation of a processing method according to certain embodiments of the present disclosure. Based on FIG. 4A, the i-th image expansion process in step S402 in FIG. 4A may include steps S4021 to S4023, which is described in conjunction with the steps shown in FIG. 4B.

Step S4021: Use the reference coding data to perform image information generation processing on the i-th input coding data to obtain the i-th generated overall expression; i and k are positive integers, and i is less than or equal to k.

In certain embodiments, during the first image expansion process, the coded data to be expanded is subjected to 100% noise. The coded data to be expanded with 100% noise is then input into the second target model for image information processing to obtain a first generated overall expression, where x is a real number greater than 0 and less than 100. During the second image expansion process, the first generated overall expression is subjected to a second noise addition, resulting in a first generated overall expression with y % noise. This is used as input to the second target model for image information processing to obtain a second generated overall expression, where y is a real number less than x and greater than 0.

Step S4022: Perform the i-th noise addition process on the coded data to be expanded to obtain the i-th original overall expression.

In certain embodiments, the image expansion process in step S4021 is repeated i times to obtain the i-th overall expression that meets the preset parameters.

Step S4023: Based on the mask image, the i-th generated overall expression and the i-th original overall expression are merged to obtain the i-th output encoded data; the mask image carries the relative position relationship between the target image and the display image; where, the first input encoded data is obtained by performing the first noise addition processing on the encoded data of the target image; the i-th output encoded data is the i+1-th input encoded data; the target encoded data is the k-th output encoded data.

In certain embodiments, the mask image is obtained by the first target model based on the relative positional relationship between the reference image and the target image, as well as the encoded data of the reference image. The mask image may serve as the content to be expanded in the target image, corresponding to the encoded data to be expanded.

In certain embodiments, the i-th generated overall expression and the i-th original overall expression are fused based on the mask image to obtain the i-th output encoded data. The i-th original overall expression is used as the background image, and the i-th generated overall expression is used as the foreground image. The background image and the foreground image are fused based on the mask image to obtain the i-th output encoded data, and the i-th output encoded data serves as the target encoded data.

In certain embodiments of the present disclosure, reference encoded data is obtained using the first target model, and the second model performs image expansion processing k times on the encoded data to be expanded based on the reference encoded data to obtain the target encoded data, thereby improving the accuracy of the image expansion.

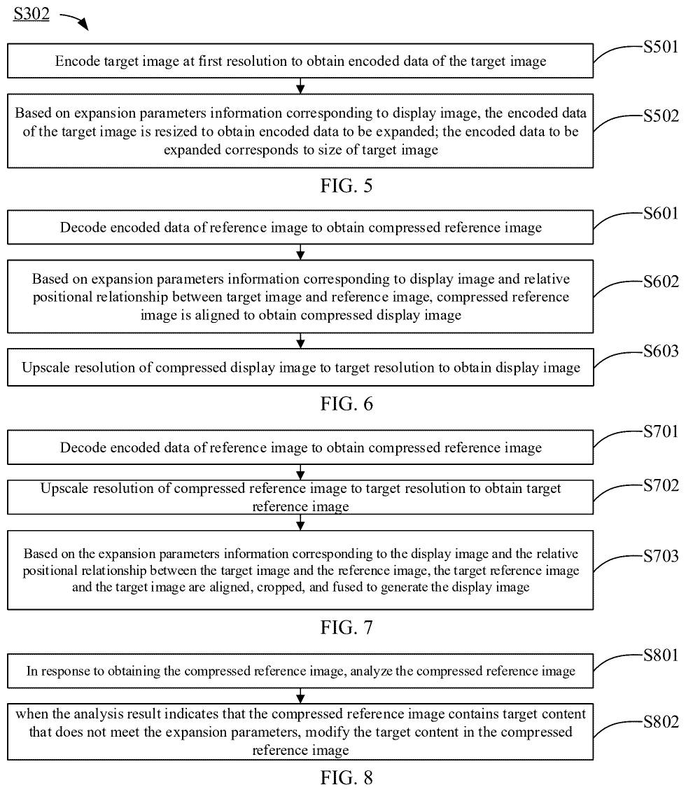

FIG. 5 is a schematic diagram of the implementation flow of an image processing method according to certain embodiments of the present disclosure. Based on FIG. 3, step S302 in FIG. 3 may be updated to steps S501 and S502, which is described in conjunction with the steps shown in FIG. 5.

Step S501: Encode the target image at the first resolution to obtain encoded data of the target image.

In certain embodiments, latent space encoding is performed on the target image at the first resolution to obtain a latent space encoding of the target image. For example, latent space encoding is performed on the target image at a resolution of 512*512 to obtain a latent space representation of the target image at a resolution of 512*512.

Step S502: Based on the expansion parameters information corresponding to the display image, the encoded data of the target image is resized to obtain the encoded data to be expanded; the encoded data to be expanded corresponds to the size of the target image.

In certain embodiments, the expansion parameters information corresponding to the display image indicates expansion parameters information for the target image.

In certain embodiments, based on the expansion parameters information for the target image, the latent space representation of the target image is resized to obtain the latent space representation to be expanded. Resizing the latent space representation of the target image may include reducing the latent space representation of the target image to match the size of the latent space representation of the reference image.

In certain embodiments of the present disclosure, the latent space representation of the target image is resized based on the expansion parameter information corresponding to the display image to improve the accuracy of the expansion of the target image.

FIG. 6 is a schematic flow diagram of an implementation of an image processing method according to certain embodiments of the present disclosure. Based on FIG. 2, the parsing result includes the relative positional relationship between the target image and the reference image. The process also includes steps S601 to S603, which is described in conjunction with the steps shown in FIG. 6.

Step S601: Decode the encoded data of the reference image to obtain a compressed reference image.

In certain embodiments, the latent space representation of the reference image is decoded to obtain the compressed reference image.

Step S602: Based on the expansion parameters information corresponding to the display image and the relative positional relationship between the target image and the reference image, the compressed reference image is aligned and cropped to obtain a compressed display image.

In certain embodiments, based on the expansion parameters information for the target image and the coordinate relationship between the target image and the target object or object in the reference image, the compressed reference image is aligned with the target image and cropped to obtain a compressed display image.

Step S603: Upscaling the resolution of the compressed display image to a target resolution to obtain the display image.

In certain embodiments, upscaling the resolution of the compressed display image to a target resolution using super-resolution technology to obtain the display image.

For example, a super-resolution process is performed on a compressed display image with a resolution of 512*512 using super-resolution technology to enlarge the horizontal pixels of the compressed display image with a resolution of 512*512 to 1920, and to enlarge the vertical pixels of the compressed display image with a resolution of 512*512 to 1080, thereby obtaining a display image with a resolution of 1920*1080.

In certain embodiments, enlarging the resolution of the compressed display image to a target resolution to obtain the display image includes: enlarging the resolution of the compressed display image to the target resolution to obtain a to-be-fused image; and fusing the to-be-fused image with the target image based on the expansion parameters information corresponding to the display image and the relative positional relationship between the target image and the reference image to obtain the display image.

In certain embodiments of the present disclosure, a latent space representation of a reference image is decoded to obtain a compressed reference image. Based on the expansion parameters for the target image and the relative positional relationship between the target image and the reference image, the compressed reference image is cropped to obtain a compressed display image. The compressed display image is super-resolved to obtain the display image, thereby improving the accuracy of the expansion of the target image.

FIG. 7 is a schematic diagram of an implementation flow of an image processing method according to certain embodiments of the present disclosure. Based on FIG. 2, the parsing result includes the relative positional relationship between the target image and the reference image. The process also includes steps S701 to S607, which is described in conjunction with the steps shown in FIG. 7.

Step S701: Decode the encoded data of the reference image to obtain a compressed reference image.

In certain embodiments, the latent space representation of the reference image is decoded to obtain a compressed reference image.

Step S702: Upscale the resolution of the compressed reference image to the target resolution to obtain a target reference image.

In certain embodiments, the resolution of the compressed reference image is upscaled to the target resolution using super-resolution technology to obtain the target reference image. For example, the super-resolution technology is used to super-resolve a reference image with a compressed resolution of 512*512, thereby upscaling the horizontal pixels of the 512*512 reference image to 1920 pixels, and upscaling the vertical pixels of the 512*512 reference image to 1080 pixels, to obtain a target reference image with a resolution of 1920*1080 pixels.

Step S703: Based on the expansion parameters information corresponding to the display image and the relative positional relationship between the target image and the reference image, the target reference image and the target image are aligned, cropped, and fused to generate the display image.

In certain embodiments, the expansion parameters information corresponding to the display image, for example, the expansion parameters information for the target image, may include expanding the left side of the target image, or expanding the target image by 30% in all four directions.

In certain embodiments, based on the expansion parameters information for the target image and the coordinate relationship between the target image and the target object or target object in the reference image, the target reference image is aligned with the target image, and the aligned target reference image is cropped to obtain a cropped target reference image; the cropped target reference image is then fused with the target image to obtain the display image.

In certain embodiments of the present disclosure, the resolution of the compressed reference image is amplified to obtain a high-resolution reference image; based on the expansion parameters information corresponding to the display image and the relative positional relationship of the coordinates, the high-resolution reference image is aligned, cropped, and fused to obtain a display image with high accuracy and resolution.

FIG. 8 is a schematic flow diagram of an image processing method according to certain embodiments of the present disclosure. The method may include steps S801 and S802, which is described in conjunction with the steps shown in FIG. 8.

Step S801: In response to obtaining the compressed reference image, analyzing the compressed reference image.

In certain embodiments, in response to obtaining the compressed reference image by decoding the latent space representation of the reference image, analyzing the target content in the compressed reference image. The analyzing the target content in the compressed reference image includes obtaining a target person or object in the compressed reference image, analyzing whether the target person or object in the compressed reference image meets the expansion parameters based on the expansion parameters of the display image, and generating an analysis result.

In certain embodiments, when the analysis result indicates that the target person or object in the compressed reference image meets the expansion parameters, the compressed reference image is aligned, cropped, and merged to obtain the display image.

Step S802: when the analysis result indicates that the compressed reference image contains target content that does not meet the expansion parameters, modifying the target content in the compressed reference image.

In certain embodiments, when the target person or object in the compressed reference image does not meet the expansion parameters corresponding to the displayed image, the target person or object in the reference image is modified based on the expansion parameters to obtain a reference image that meets the expansion parameters.

In certain embodiments of the present disclosure, the target content in the reference image is analyzed to determine whether the target content in the reference image meets the expansion parameters. If not, the target content in the reference image is modified to improve the accuracy of the expansion of the target image.

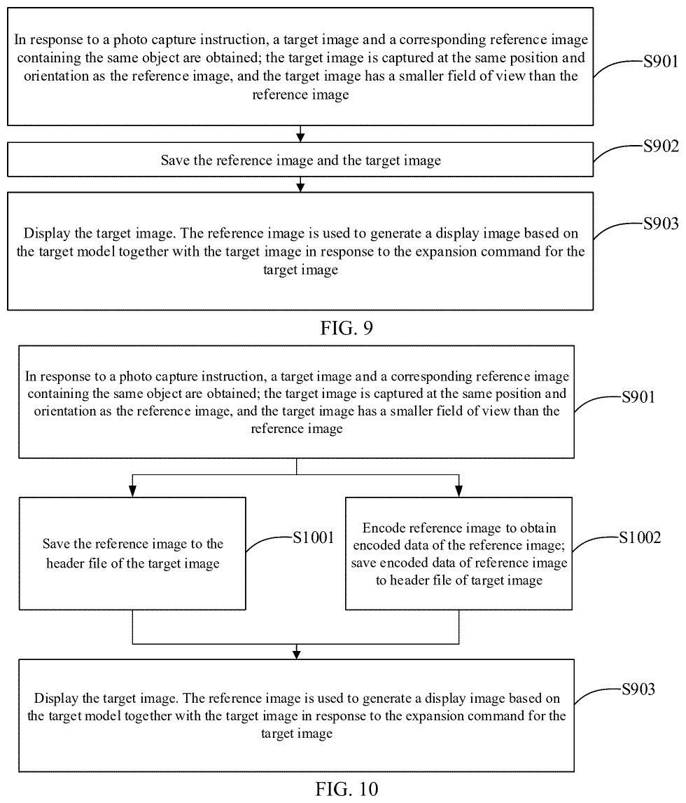

FIG. 9 is a schematic flow diagram of an implementation of an image processing method according to certain embodiments of the present disclosure. The method may include steps S901 to S903, which is described in conjunction with the steps shown in FIG. 9.

Step S901: In response to a photo capture instruction, a target image and a corresponding reference image containing the same object are obtained; the target image is captured at the same position and orientation as the reference image, and the target image has a smaller field of view than the reference image.

In certain embodiments, in response to a photo capture instruction for a target person or target object, the target person or target object is shot by at least one shooting device at the same position and in the same direction to obtain a target image and a reference image, where the field of view angle of the target image is smaller than the field of view angle of the reference image.

In certain embodiments, when the target person or object is photographed by a single camera to obtain a target image and a reference image, the following steps may be performed: when the target person or object is photographed by the camera at the same time, the target image is captured using the camera's wide-angle lens, and the reference image is captured using the camera's wide-angle lens. When the target person or object is photographed by the camera at different times, the target image and the reference image are captured at the same shooting position and orientation, and the field of view of the camera when capturing the reference image is greater than the field of view of the camera when capturing the target image. The field of view of the target person or object in the reference image is greater than the field of view of the target person or object in the target image.

Step S902: Saving the reference image and the target image.

In certain embodiments, the reference image and the target image are saved to the camera's memory, where the target image and the reference image are associated with each other, and the reference image is retrieved in response to a command to expand the target image.

In certain embodiments, the reference image is saved in the header file of the target image, and when a command to expand the target image is received, the header file of the target image is parsed to obtain the reference image; or the latent space representation of the reference image is saved in the header file of the target image, and when a command to expand the target image is received, the header file of the target image is parsed to obtain the latent space representation of the reference image.

Step S903: Displaying the target image. The reference image is used to generate a display image based on the target model together with the target image in response to the expansion command for the target image. The display image has a larger size than the target image and includes the image content of the target image and the expanded content.

In certain embodiments, the target image is displayed on the display screen of a camera device; in response to an expansion instruction for the target image, the reference image is called based on the association information between the target image and the reference image; or the header file of the target image is parsed to obtain the reference image or a latent space representation of the reference image; expanded content for the target image is generated based on the reference image, and the expanded content and the target image are combined to generate a display image based on a target model, where the size of the display image is larger than that of the target image; the expanded display image is super-resolution processed to obtain a high-resolution display image.

In certain embodiments of the present disclosure, in response to an expansion instruction for the target image, the target model generates expanded content for the target image using the reference image, and generates the display image based on the expanded content and the target image, thereby improving the accuracy of image expansion.

FIG. 10 is a schematic flow diagram of an implementation of an image processing method according to certain embodiments of the present disclosure. Based on FIG. 9, step S902 in FIG. 9 may be updated to step S1001 or step S1002, and the steps shown in FIG. 10 is described below.

Step S1001: Save the reference image to the header file of the target image.

In certain embodiments, the reference image in Joint Photographic Experts Group (JPEG) format is saved in the header file of the target image based on the JPEG multi-image file format.

Step S1002: Encode the reference image to obtain encoded data of the reference image; save the encoded data of the reference image to the header file of the target image.

In certain embodiments, latent space encoding is performed on the reference image to obtain a latent space encoding of the reference image, and the latent space representation of the reference image is saved in the header file of the target image.

In certain embodiments, the reference image's index information is stored in the target image's header file, and the reference image or its latent space representation is stored in the target image's footer.

In certain embodiments of the present disclosure, by storing the reference image or its latent space representation in the target image's header file, efficiency in expanding the target image may be improved.

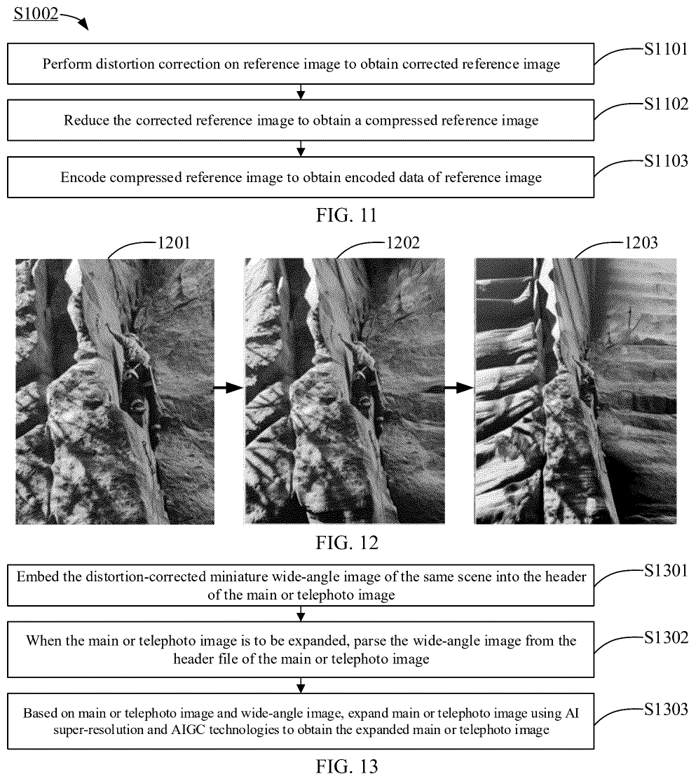

FIG. 11 is a schematic flow diagram illustrating an implementation of an image processing method according to certain embodiments of the present disclosure. Based on FIG. 10, step S1002 in FIG. 10 may be updated to steps S1101 to S1103, which is described in conjunction with the steps shown in FIG. 11.

Step S1101: Perform distortion correction on the reference image to obtain a corrected reference image.

In certain embodiments, distortion correction is performed on the reference image to reduce or eliminate the effects of image distortion caused by the camera lens or the imaging process, thereby obtaining a corrected reference image.

Step S1102: Reduce the corrected reference image to obtain a compressed reference image.

In certain embodiments, the size of the corrected reference image is reduced, that is, the resolution of the corrected reference image is reduced, to obtain a compressed reference image.

Step S1103: Encode the compressed reference image to obtain encoded data of the reference image.

In certain embodiments, latent space encoding is performed on the compressed reference image to obtain a latent space representation of the reference image.

In certain embodiments of the present disclosure, distortion correction is performed on the reference image to reduce or eliminate the effects of image distortion caused by the camera lens or the imaging process, thereby improving the accuracy of the target image expansion.

The following describes an exemplary implementation of an image processing method provided in embodiments of the present disclosure.

With technological advancements, AI image expansion has become a sought-after feature in the industry. AI image expansion uses artificial intelligence generated content (AIGC) technology to expand the viewing angle of a target image based on an original real-world image. FIG. 12 shows a schematic diagram of an image expansion method implemented in certain embodiments of the present disclosure. 1201 is the original image, 1202 is the image expanded 1.5 times using AIGC technology, and 1203 is the image expanded 2 times using AIGC technology. However, image expansion using AIGC technology may violate real-world conditions. For example, in FIG. 1203, the expanded area below the figure lacks a rope, which contradicts common sense.

FIG. 13 shows a schematic diagram of the implementation flow of an image expansion method implemented in certain embodiments of the present disclosure. The method includes steps S1301 to S1303, which is described in conjunction with the steps shown in FIG. 13.

Step S1301: Embed the distortion-corrected miniature wide-angle image of the same scene into the header of the main or telephoto image.

In certain embodiments, when a target object is captured using the main or telephoto lens of a camera or other mobile device to obtain a main or telephoto image, a wide-angle image of the target object is captured using the wide-angle lens of the camera or other mobile device. The distortion-corrected miniature wide-angle image of the same scene is embedded into the header of the main or telephoto image. The distortion-corrected miniature wide-angle image is embedded into the header of the main or telephoto image.

In certain embodiments, after the wide-angle image is corrected for deformity, the key points in the wide-angle image are aligned with the key points in the main camera image or the telephoto image to generate a mapping relationship between the coordinates in the main camera image or the telephoto image and the wide-angle image. The wide-angle image is scaled down based on the mapping relationship between the coordinates in the main camera image or the telephoto image and the wide-angle image to reduce the impact of the large size of the wide-angle image on the size of the main camera image or the telephoto image. The coordinate correspondence between the reduced-size wide-angle image and the main camera image or the telephoto image is stored in the header file of the main camera image or the telephoto image. The index information of the reduced-size wide-angle image may be stored in the header file of the main camera image or the telephoto image, and the coordinate correspondence between the reduced-size wide-angle image and the main camera image or the telephoto image is stored in the tail file of the main camera image or the telephoto image.

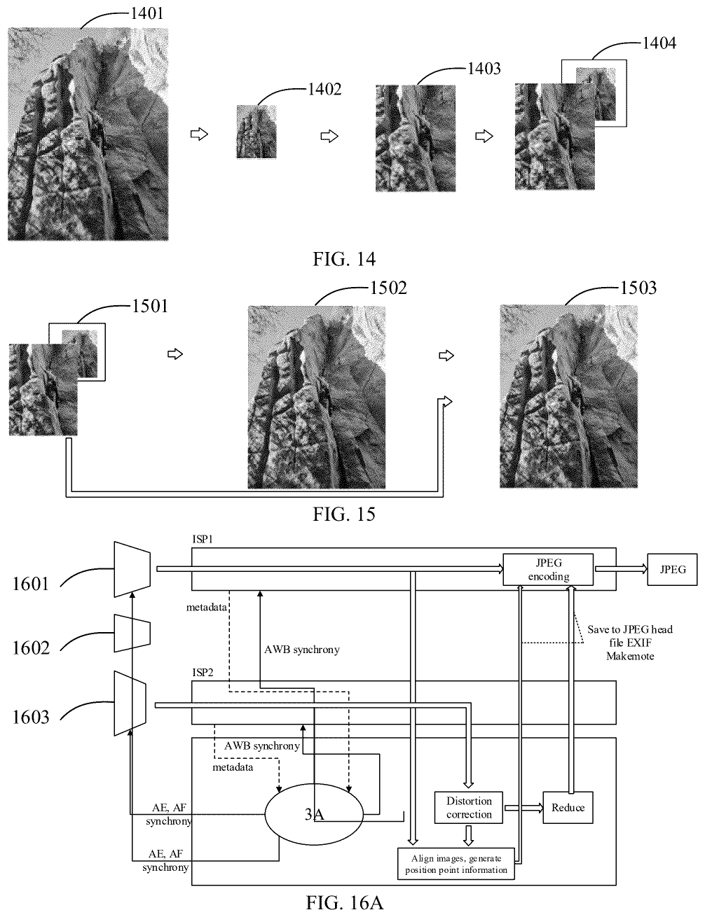

FIG. 14 is a schematic diagram illustrating an implementation of wide-angle image storage provided by certain embodiments of the present disclosure. As shown in FIG. 14, 1401 represents a wide-angle image after distortion correction; 1402 represents downscaling the distortion-corrected wide-angle image to obtain a downscaled wide-angle image; 1403 represents writing the downscaled wide-angle image to the header extension data area of the main or telephoto image; and 1404 represents storing the main or telephoto image and its header extension data area.

Step S1302: When the main or telephoto image is to be expanded, parse the wide-angle image from the header file of the main or telephoto image.

Step S1303: Based on the main or telephoto image and the wide-angle image, expand the main or telephoto image using AI super-resolution and AIGC technologies to obtain the expanded main or telephoto image.

In certain embodiments, AI super-resolution technology is an image processing technique based on deep learning and neural network algorithms, designed to upscale low-resolution images or videos to high resolution. AI super-resolution technology extracts footage from low-resolution images or videos to generate high-resolution images. AI super-resolution technology supports 8× super-resolution. For example, a 320×240 wide-angle thumbnail image may be super-resolved 8× to a resolution of 2560×1920.

In certain embodiments, AI super-resolution technology is used to upscale a wide-angle image from a main camera or telephoto image to the target resolution. The image is then aligned with key points of the main camera or wide-angle image based on coordinate correspondences. The aligned wide-angle image is fused and transitioned with the main camera or wide-angle image, merging the wide-angle image and the main camera or wide-angle image into a single image.

In certain embodiments, when an AI model is used to expand the main or telephoto image, it uses the miniature wide-angle image as a reference, rather than relying solely on information from the miniature wide-angle image. When the wide-angle image contains content inappropriate for display, the AI model may be prompted to ignore the inappropriate content through voice or text commands. This inappropriate content may include spam, violent images, and the like.

In other embodiments, AIGC technology may be used to design and train a model using the main or telephoto image and the miniature wide-angle image as input, and an expanded image may be generated based on the trained model.

FIG. 15 is a schematic diagram illustrating an implementation of an image expansion method according to certain embodiments of the present disclosure. As shown in FIG. 15, 1501 indicates reading a wide-angle image from the head expansion area of the main or telephoto image; 1502 indicates upscaling the resolution of the wide-angle image using an AI super-resolution model; and 1503 indicates fusing the main or telephoto image with the upscaled wide-angle image using the AIGC technology model to generate the expanded image.

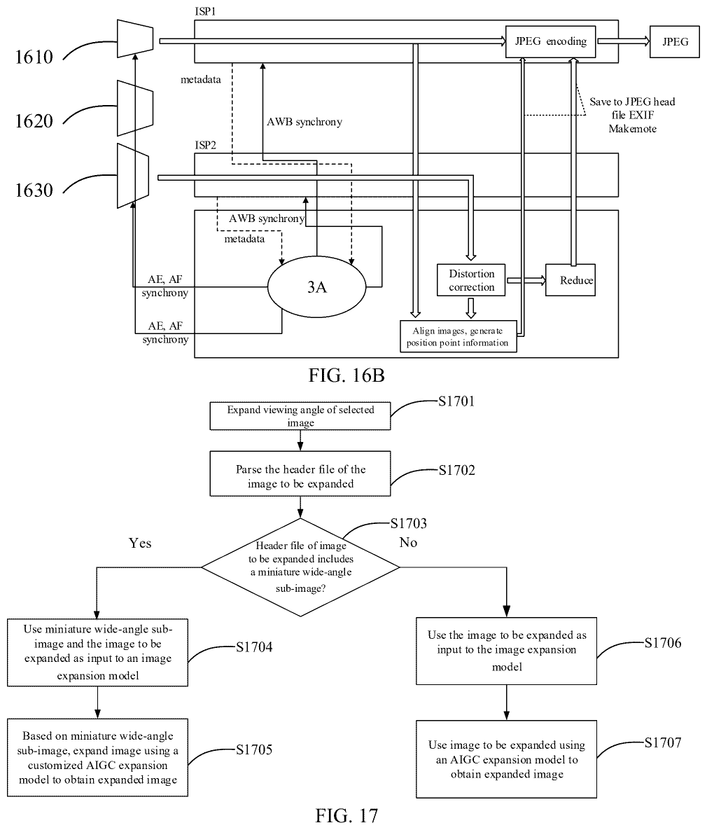

FIG. 16A is a schematic diagram illustrating an implementation of a shooting principle provided by certain embodiments of the present disclosure. Referring to FIG. 16, reference numeral 1601 represents a main camera, reference numeral 1602 represents a telephoto camera, and reference numeral 1603 represents a wide-angle camera. When a user shoots with the main camera, main camera 1601 responds to a shooting command and captures a main image of the current scene. Wide-angle camera 1603 captures a wide-angle image, performs distortion correction on the wide-angle image, aligns the wide-angle image with the main image, and generates corresponding point information. The wide-angle image is then scaled down. Main camera 1601 also stores the scaled-down wide-angle image and the corresponding point information in the main image header file and encodes the main image, the scaled-down wide-angle image, and the corresponding point information to obtain an encoded main image.

FIG. 16B is a schematic diagram illustrating an implementation of a shooting principle according to certain embodiments of the present disclosure. As shown in FIG. 16B, reference numeral 1610 represents a telephoto camera, reference numeral 1620 represents a main camera, and reference numeral 1630 represents a wide-angle camera. When a user shoots with telephoto camera 1610, telephoto camera 1610 responds to a shooting command and captures a telephoto image of the current scene. Wide-angle camera 1630 captures a wide-angle image, performs distortion correction on the wide-angle image, aligns the wide-angle image with the telephoto image, and generates corresponding point information. The wide-angle image is then scaled down. Telephoto camera 1610 also stores the scaled-down wide-angle image and the corresponding point information in the telephoto image header file and encodes the telephoto image, the scaled-down wide-angle image, and the corresponding point information to obtain an encoded telephoto image.

FIG. 17 is a schematic diagram illustrating an implementation flow of an image enlargement method according to certain embodiments of the present disclosure. The method includes steps S1701 to S1707, which is described in conjunction with the steps shown in FIG. 7.

Step S1701: Expand the viewing angle of the selected image.

In certain embodiments, among the images selected for expansion, select the viewing angle to be expanded to obtain the image to be expanded.

Step S1702: Parse the header file of the image to be expanded.

In certain embodiments, parse the header file of the image to be expanded.

Step S1703: Determine whether the header file of the image to be expanded includes a miniature wide-angle sub-image.

Step S1704: Use the miniature wide-angle sub-image and the image to be expanded as input to an image expansion model.

Step S1705: Based on the miniature wide-angle sub-image and the image to be expanded, expand the image using a customized AIGC expansion model to obtain an expanded image.

Step S1706: Use the image to be expanded as input to the image expansion model.

Step S1707: Use the image to be expanded using an AIGC expansion model to obtain an expanded image.

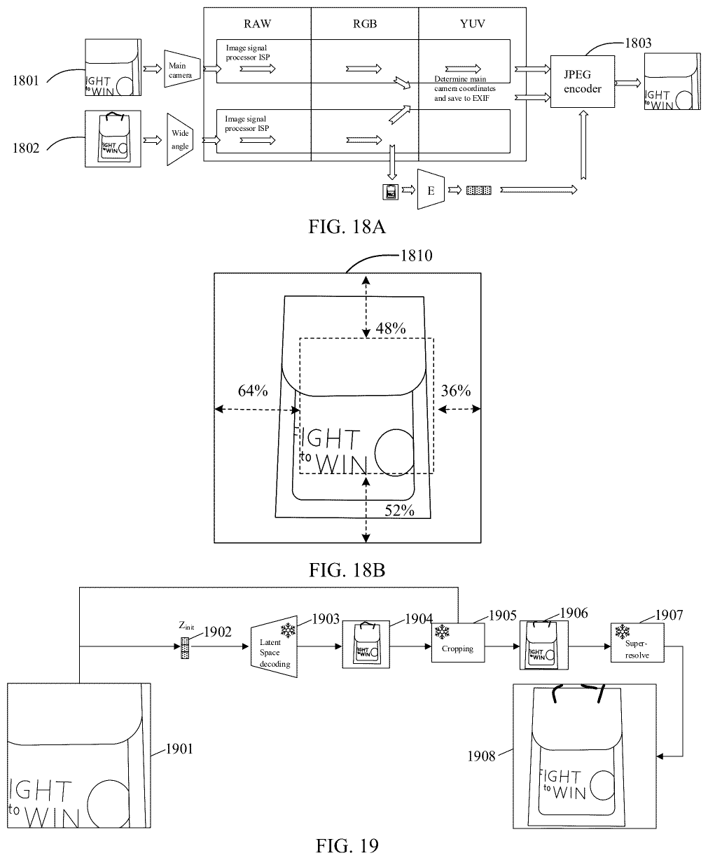

FIG. 18A is a schematic diagram of an implementation of a shooting end architecture provided by certain embodiments of the present disclosure. As shown in FIG. 18A, it includes a main camera architecture 1801, a wide-angle camera architecture 1802, and an encoder 1803; where, the main camera architecture 1801 is used to send the main camera image in RAW format to the encoder 1803 after passing through the RGB domain and YUV domain; the wide-angle camera architecture 1802 is used to take wide-angle photos of the same scene when taking pictures through the main camera (or telephoto lens); the wide-angle image in RAW format taken by the wide-angle camera is converted into a latent space expression in the RGB domain through the latent space encoder, and the latent space expression of the wide-angle image is sent to the encoder N03, which is used to obtain the correspondence between the coordinates in the main camera image and the wide-angle image in the RGB domain according to the main camera image, and store the correspondence between the coordinates in the header file of the main camera image; the encoder 1803 encodes the latent space expressions of the main camera image and the wide-angle image with the coordinate correspondence stored to obtain the encoded main camera image. The encoded main camera image may be used as input for AIGC image expansion operations on the album side. Storing the latent space representation in the main camera image header file may not only reduce space usage (the latent space encoder has a higher compression rate than JPEG) but also speed up subsequent AIGC image expansion operations compared to storing JPGs.

FIG. 18B is a schematic diagram illustrating an implementation of an expanded image provided by certain embodiments of the present disclosure. As shown in FIG. 18B, to expand the main camera image in multiple directions, the main camera image is expanded based on the wide-angle image, resulting in expanded image 1810. Expanded image 1810 shows that, compared to the target image, the expanded image 1810 has been expanded by 64% to the left, 36% to the right, 48% upward, and 52% downward.

In certain embodiments, when expanding the main camera (or telephoto) image, the latent space representation of the wide-angle image is directly used to restore the wide-angle image. Based on the positional relationship between the main camera (or telephoto) and the wide-angle image (determined during the capture phase and stored in the EXIF file), as well as the user's expansion direction and ratio, the restored wide-angle image is determined to be cropped or further expanded without reference.

FIG. 19 is a schematic diagram illustrating an implementation of an image expansion method provided by certain embodiments of the present disclosure. As shown in FIG. 19, the system includes a main image 1901, a noise addition module 1902, a decoding module 1903, a wide-angle image 1904, a cropping module 1905, a cropped wide-angle image 1906, a super-resolution module 1907, and an extended image 1908. The main image 1901 is parsed to obtain a latent space representation of the wide-angle image and the positional relationship between the wide-angle image and the main image. The noise addition module 1902 adds noise to the latent space representation of the wide-angle image. The decoding module 1903 performs latent space decoding on the noisy latent space representation to obtain the wide-angle image 1904. The cropping module 1905 crops the wide-angle image 1904 to obtain a cropped wide-angle image 1906. The super-resolution module 1907 performs super-resolution processing on the cropped wide-angle image 1906 to obtain an extended image 1908.

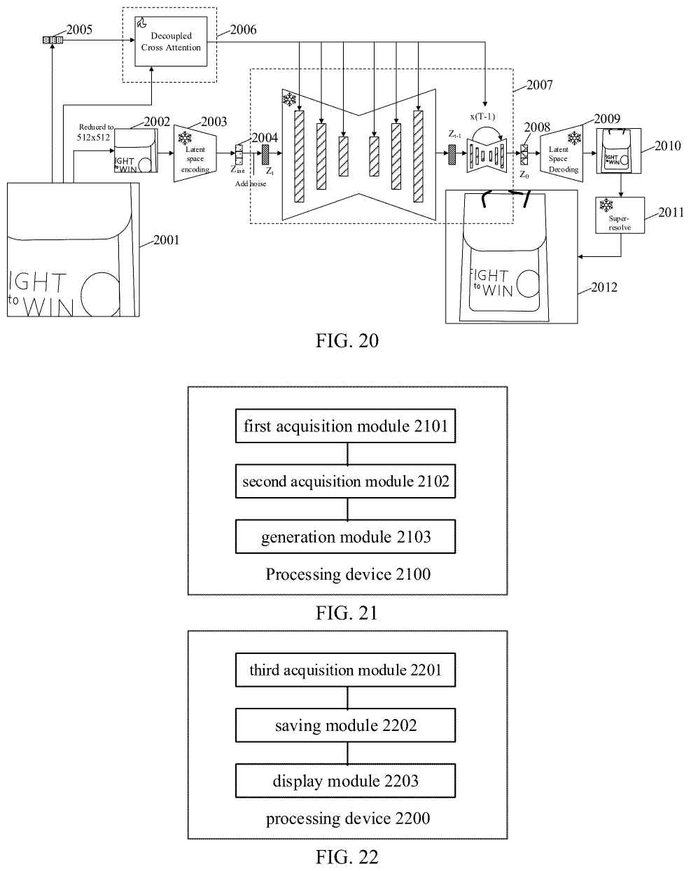

FIG. 20 is a schematic diagram illustrating an implementation of an image expansion method according to certain embodiments of the present disclosure. As shown in FIG. 20, the main camera image 2001, the reduced main camera image 2002, the encoding module 2003, the noise adding module 2004, the parsing module 2005, the first target model 2006, the second target model 2007, the target latent space expression 2008, the decoding module 2009, the extended image 2010, the super-resolution module 2011, and the target extended image 2012 are included. The size of the main camera image 2001 is reduced to obtain the reduced main camera image 2002; the encoding module 2003 performs latent space decoding on the reduced main camera image 2002 to obtain the latent space expression of the reduced main camera image 2002; the noise adding module 2004 performs the noise adding module 2005 on the reduced main camera image 2006. The latent space expression of the image 2002 is denoised to obtain the latent space expression of the noisy main camera image; the main camera image 2001 is processed by the parsing module 2005; the reference latent space expression is obtained based on the latent space expression of the wide-angle image and the positional relationship between the wide-angle image and the main camera image by the first model 2006; the target latent space expression 2008 is obtained based on the latent space expression of the noisy main camera image and the reference latent space expression by the second model 2007; the target latent space expression 2008 is latently decoded by the decoding module 2009 to obtain the extended image 2010; the extended image 2010 is super-resolved by the super-resolution module 2011 to obtain the target extended image 2012.

In certain embodiments of the present disclosure, the main or telephoto image is expanded based on a target model using the latent space representation of the wide-angle image or wide-angle image stored in the main or telephoto image header file, as well as the relative positional relationship between the main or telephoto image and the wide-angle image. This expanded image is processed using super-resolution techniques to obtain an expanded image at the target resolution, thereby improving the accuracy of image expansion and the resolution of the expanded image.

An image processing device is provided. The image processing device includes various units and modules included in each unit. This device may be implemented by a processor in an electronic device, or by a logic circuit. In implementation, the processor may be a central processing unit (CPU), a microprocessor (MPU), a digital signal processor (DSP), or a field programmable gate array (FPGA).

FIG. 21 is a schematic diagram of the structure of an image processing device according to certain embodiments of the present disclosure. As shown in FIG. 21, the image processing device 2100 includes: a first acquisition module 2101, a second acquisition module 2102, and a generating module 2103. The first acquisition module 2101 is configured to obtain a target image; the second acquisition module 2102 is configured to obtain a reference image. The target image is captured at the same location and orientation as the reference image, and the target image has a smaller field of view than the reference image. The generation module 2103 is configured to generate a display image based on a target model, the reference image, and the target image. The display image is larger than the target image and includes the target image content and expanded content. The expanded content is generated based on the target model, the reference image, and the target image to expand the display content in at least one direction of the target image.

In certain embodiments, the second acquisition module 2102 is further configured to parse the target image and generate a parsing result. The parsing result includes the reference image, which is encoded data stored in a file containing the target image.

In certain embodiments, the parsing result also includes the relative positional relationship between the target image and the reference image. The generation module 2103 is further configured to reduce the resolution of the target image to obtain a target image of a first resolution; perform encoding processing on the target image of the first resolution to obtain the encoded data to be expanded; perform feature fusion on the encoded data to be expanded and the encoded data of the reference image based on the relative positional relationship between the target image and the reference image using the target model to obtain target encoded data; perform decoding processing on the target encoded data to obtain a display image of the first resolution; and enlarge the display image of the first resolution to the target resolution to obtain the display image.

In certain embodiments, the target model includes a first target model and a second target model; the generation module 2103 is further configured to perform feature transformation on the relative positional relationship between the target image and the reference image and the encoded data of the reference image using the first target model to obtain reference encoded data; the reference encoded data carries image features of each position in the reference image from the perspective of the target image; and perform an iterative image expansion process k times based on the reference encoded data using the second target model to obtain the target encoded data.

The i-th image expansion process includes:
Using the reference coded data to perform image information generation processing on the i-th input coded data to obtain the i-th generated overall representation; i and k are positive integers, with i less than or equal to k;
Performing the i-th noise addition process on the coded data to be expanded to obtain the i-th original overall representation;
Fusing the i-th generated overall representation with the i-th original overall representation based on a mask image to obtain the i-th output coded data; the mask image carries the relative positional relationship between the target image and the display image;
The first input coded data is obtained by performing the first noise addition process on the coded data of the target image; the i-th output coded data is the coded data of the i+1-th input; and the target coded data is the coded data of the k-th output.

In certain embodiments, the image processing device 2100 further includes an encoding module (not shown) configured to encode the target image at the first resolution to obtain encoded data of the target image;
based on the expansion parameters information corresponding to the display image, resize the encoded data of the target image to obtain the encoded data to be expanded; the encoded data to be expanded corresponds to the size of the target image.

In certain embodiments, the parsing result includes the relative positional relationship between the target image and the reference image; the generation module 2103 is further configured to decode the encoded data of the reference image to obtain a compressed reference image; align and crop the compressed reference image based on the expansion parameters information corresponding to the display image and the relative positional relationship between the target image and the reference image to obtain a compressed display image; and upscale the resolution of the compressed display image to the target resolution to obtain the display image.

In certain embodiments, the generation module 2103 is further configured to decode the encoded data of the reference image to obtain a compressed reference image; upscale the resolution of the compressed reference image to a target resolution to obtain a target reference image; and, based on the expansion parameters information corresponding to the display image and the relative positional relationship between the target image and the reference image, perform image alignment, cropping, and image fusion on the target reference image and the target image to generate the display image.

In certain embodiments, the processing device 2100 further includes an analysis module (not shown) configured to analyze the compressed reference image in response to obtaining the compressed reference image;
When the analysis results indicate that the compressed reference image contains target content that does not meet the expansion parameters, modify the target content in the compressed reference image.

FIG. 22 is a schematic diagram of an image processing device provided by certain embodiments of the present disclosure. As shown in FIG. 22, the image processing device 2200 includes: a third acquisition module 2201, a saving module 2202 and a display module 2203, where: the third acquisition module 2201 is used to respond to a photo capture instruction to obtain a target image and a corresponding reference image including the same object; the shooting position of the target image is the same as the shooting position of the reference image, the shooting direction of the target image is the same as the shooting direction of the reference image, and the field of view angle of the target image is smaller than the field of view angle of the reference image; the saving module 2202 is used to save the reference image and the target image; the display module 2203 is used to display the target image; the reference image is used to respond to the extension instruction for the target image, and generate a display image together with the target image based on the target model, the size of the display image is larger than the size of the target image, and the display image includes the image content of the target image and the expanded content.

In certain embodiments, the saving module 2202 is further configured to save the reference image to the header file of the target image; or to encode the reference image to obtain encoded data of the reference image; and to save the encoded data of the reference image to the header file of the target image.

In certain embodiments, the image processing device 2200 further includes an encoding module (not shown) configured to perform distortion correction on the reference image to obtain a corrected reference sub-image; to reduce the corrected reference sub-image to obtain a compressed reference image; and to encode the compressed reference image to obtain encoded data of the reference image.

The description of the device embodiments is similar to the description of the method embodiments and has similar beneficial effects as the method embodiments. In certain embodiments, the functions or modules included in the device embodiments may be used to perform the method embodiments. For technical details not disclosed in the device embodiments of the present disclosure, the description of the method embodiments of the present disclosure may be referred to for an understanding.

In certain embodiments of the present disclosure, when the method is implemented as a software functional module and sold or used as a standalone product, the method may be stored in a computer-readable storage medium. The technical solutions of the embodiments of the present disclosure may be embodied in the form of a software product. This software product is stored in a storage medium and includes a number of instructions for enabling an electronic device (which may be a personal computer, server, or network device, or the like) to execute all or part of the methods described in the various embodiments of the present disclosure. The storage medium includes various media that may store program code, such as a USB flash drive, a mobile hard drive, a read-only memory (ROM), a magnetic disk, or an optical disk. Thus, the embodiments of the present disclosure are not limited to any specific hardware, software, or firmware, or any combination of hardware, software, and firmware.

Certain embodiments of the present disclosure provide an electronic device including a display screen, a memory, and a processor. The display screen is configured to display images. The memory stores a computer program executable on the processor. When the processor executes the program, some or all of the steps in the above-described method are implemented.

Certain embodiments of the present disclosure provide a computer-readable storage medium storing a computer program. When the computer program is executed by the processor, some or all of the steps in the above-described method are implemented. The computer-readable storage medium may be volatile or non-volatile.

Certain embodiments of the present disclosure provide a computer program including computer-readable code. When the computer-readable code is executed in an electronic device, the processor in the electronic device executes the program to implement some or all of the steps in the above-described method.

Certain embodiments of the present disclosure provide a computer program product comprising a non-volatile computer-readable storage medium storing the computer program. When the computer program is read and executed by a computer, some or all of the steps in the above-described method are implemented. The computer program product may be implemented in hardware, software, or a combination thereof. In certain embodiments, the computer program product is embodied as a computer storage medium. In certain embodiments, the computer program product is embodied as a software product, such as a software development kit (SDK).

The descriptions of the various embodiments above tend to emphasize the differences between the various embodiments, and their similarities or similarities may be referenced to each other. The descriptions of the above device, storage medium, computer program, and computer program product embodiments are similar to the descriptions of the above method embodiments and have similar beneficial effects as the method embodiments. For technical details not disclosed in the embodiments of the device, storage medium, computer program, and computer program product of this application, the description of the method embodiments may be referred to for understanding.

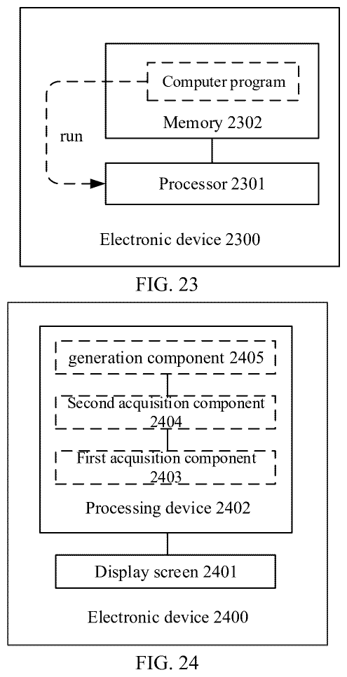

FIG. 23 is a schematic diagram of the hardware components of an electronic device according to certain embodiments of the present disclosure. As shown in FIG. 23, the hardware components of electronic device 2300 include a processor 2301 and a memory 2302. Memory 2302 stores a computer program executable on processor 2301. When processor 2301 executes the program, it implements the steps of any of the methods described in the aforementioned embodiments.

Memory 2302 stores a computer program executable on the processor. Memory 2302 is configured to store instructions and applications executable by processor 2301. Memory 2302 may cache data (for example, image data, audio data, voice communication data, and video communication data) to be processed or already processed by processor 2301 and various modules in electronic device 2300. This may be implemented using flash memory (FLASH) or random access memory (RAM).

When processor 2301 executes the program, it implements the steps of any of the methods described in the aforementioned embodiments. Processor 2301 generally controls the overall operation of electronic device 2300.

FIG. 24 is a schematic diagram of a hardware entity of an electronic device according to certain embodiments of the present disclosure. As shown in FIG. 24, the hardware entity of the electronic device 2400 includes: a display screen 2401 and an image processing device 2402, where the display screen 2401 is used to display a picture; the image processing device 2402 includes a first acquisition component 2403, a second acquisition component 2404 and a generation component 2405; where the first acquisition component 2403 is used to obtain a target image; the second acquisition component 2404 is used to obtain a reference image, the shooting position of the target image is the same as the shooting position of the reference image, and the target image The shooting orientation of the image is the same as that of the reference image, and the field of view of the target image is smaller than that of the reference image. A generation component 2405 is configured to generate a display image based on the target model, the reference image, and the target image. The display image is larger than the target image and includes the image content of the target image and expanded content, where the expanded content is generated based on the target model, the reference image, and the target image to expand the display content of the target image in at least one direction. The display screen 2401 is configured to display the target image.

Certain embodiments of the present disclosure provide a computer storage medium storing one or more programs, which may be executed by one or more processors to implement the steps of the method described in any of the above embodiments.

The description of the above storage medium and device embodiments is similar to the description of the method embodiments and has similar beneficial effects as the method embodiments. For technical details not disclosed in the storage medium and device embodiments of this application, the description of the method embodiments may be referred to for an understanding.

The above-mentioned processor may be at least one of an application-specific integrated circuit (ASIC), a digital signal processor (DSP), a digital signal processing device (DSPD), a programmable logic device (PLD), a field programmable gate array (FPGA), a central processing unit (CPU), a controller, a microcontroller, and a microprocessor. The electronic device that implements the functions of the above-mentioned processor may also be other electronic devices, and is not limited in the present disclosure.

The computer storage medium/memory may be a read-only memory (ROM), a programmable read-only memory (PROM), an erasable programmable read-only memory (EPROM), an electrically erasable programmable read-only memory (EEPROM), a magnetic random access memory (FRAM), a flash memory (Flash Memory), a magnetic surface storage device, an optical disc, or a compact disc read-only memory (CD-ROM); it may be various terminals that include one or any combination of the above-mentioned memories, such as mobile phones, computers, tablet devices, personal digital assistants, or the like.

When applicable, terms “one embodiment” or “certain embodiments” refer to a particular feature, structure, or characteristic. Therefore, the appearance of “in one embodiment” or “in certain embodiments” does not necessarily refer to the same embodiment. Furthermore, these particular features, structures, or characteristics may be combined in any suitable manner in one or more embodiments. In the various embodiments of the present disclosure, the order of the steps/processes described above does not necessarily indicate a sequential order of execution. The order of execution of the steps/processes is determined by their functionality and inherent logic and does not constitute any limitation on the implementation of the embodiments of the present disclosure. The numbers of the embodiments of the present disclosure are for descriptive purposes only and do not represent superiority or inferiority of the embodiments.

When applicable, the terms “include” and “comprise” or any other variations thereof are intended to encompass non-exclusive inclusion, such that a process, method, article, or apparatus includes not only those elements expressly stated but also other elements not expressly listed, or elements inherent to such process, method, article, or apparatus. An element defined by the phrase “comprising a . . . ” does not preclude the presence of additional elements in the process, method, article, or apparatus.

Disclosed devices and methods may be implemented in other ways. The device embodiments described above are illustrative. For example, the division of units described is a logical functional division. Actual implementations may employ other divisions, such as combining multiple units or components, integrating them into another system, or omitting or disabling certain features. Furthermore, the coupling, direct coupling, or communication connection between the components shown or discussed may be through interfaces. Indirect coupling or communication connections between devices or units may be electrical, mechanical, or other forms.

The units described above as separate components may or may not be physically separate, and the components shown as units may or may not be physical units. They may be located in a single location or distributed across multiple network units. Some or all of these units may be selected to achieve any intended objectives.

In addition, the functional units in the various embodiments of the present disclosure may be integrated into a single processing unit, each unit may be a separate unit, or two or more units may be integrated into a single unit. These integrated units may be implemented in hardware or as hardware plus software functional units. All or part of the steps of the method embodiments may be performed by hardware associated with program instructions. The program may be stored in a computer-readable storage medium, which, when executed, performs the steps of the above method embodiments. Such storage medium includes various media capable of storing program code, such as removable storage devices, read-only memories (ROMs), magnetic disks, or optical disks.

When the integrated units of the present disclosure are implemented as software functional modules and sold or used as standalone products, they may also be stored in a computer-readable storage medium. The technical solution of this application, or the portion that contributes to the relevant art, may be embodied in the form of a software product. This computer software product, stored on a storage medium, includes instructions for enabling an electronic device (such as a personal computer, server, or network device) to perform all or part of the method. The storage medium includes various media capable of storing program code, such as removable storage devices, ROMs, magnetic disks, or optical disks.

The scope of protection of the present disclosure is not limited by the embodiments described herein. Any modifications or substitutions readily conceived by a person skilled in the technical field are intended to be covered by the scope of protection of the present disclosure.

What is claimed is:

1. An image processing method, comprising:
obtaining a target image and a reference image, the target image having a smaller field of view than the reference image; and
using a target model to generate a display image from the reference image and the target image, wherein the display image includes image content of the reference image and is larger than the target image.

2. The image processing method of claim 1, wherein the target image is captured at a same location as the reference image.

3. The image processing method of claim 1, wherein the target image is captured at a same orientation as the reference image.

4. The image processing method according to claim 1, where obtaining the reference image includes:
parsing the target image to generate a parsing result; and
obtaining the reference image from the parsing result.

5. The image processing method of claim 1, wherein generating the display image includes:
reducing a resolution of the target image to obtain a target image of a first resolution;
encoding the target image of the first resolution to obtain encoded data;
using the target model to perform feature fusion on the encoded data to obtain target encoded data;
decoding the target encoded data to obtain a display image of the first resolution; and
enlarging the display image of the first resolution to a target resolution to obtain the display image.

6. The image processing method of claim 5, wherein the feature fusion is performed by further using a relative positional relationship between the target image and the reference image.

7. The image processing method according to claim 5, further comprising:
resizing the encoded data, the encoded data corresponding to a size of the target image.

8. The image processing method of claim 1, wherein the target model includes a first target model and a second target model, the first target model is configured to perform feature transformation on a relative positional relationship between the target image and the reference image to obtain reference coded data of the reference image, and the second target model is configured to perform an iterative image expansion process k times on coded data of the target image according to the reference coded data to obtain target coded data.

9. The image processing method according to claim 1, wherein generating the display image includes:
decoding the reference image to obtain a compressed reference image;
according to a relative positional relationship between the target image and the reference image, processing the compressed reference image to obtain a compressed display image; and
enlarging a resolution of the compressed display image to a target resolution to obtain the display image.

10. An electronic device, comprising: a memory storing computer program instructions; and a processor coupled to the memory and configured to execute the computer program instructions and perform:
obtaining a target image and a reference image, the target image having a smaller field of view than the reference image; and
using a target model to generate a display image from the reference image and the target image, wherein the display image includes image content of the reference image and is larger than the target image.

11. The electronic device of claim 10, wherein the target image is captured at a same location as the reference image.

12. The electronic device of claim 10, wherein the target image is captured at a same orientation as the reference image.

13. The electronic device of claim 10, wherein obtaining the reference image includes:
parsing the target image to generate a parsing result; and
obtaining the reference image from the parsing result.

14. The electronic device of claim 10, wherein generating the display image includes:
reducing a resolution of the target image to obtain a target image of a first resolution;
encoding the target image of the first resolution to obtain encoded data;
using the target model to perform feature fusion on the encoded data to obtain target encoded data;
decoding the target encoded data to obtain a display image of the first resolution; and
enlarging the display image of the first resolution to a target resolution to obtain the display image.

15. The electronic device of claim 14, wherein the feature fusion is performed by further using a relative positional relationship between the target image and the reference image.

16. The electronic device of claim 14, wherein the processor is further configured to perform:
resizing the encoded data, the encoded data corresponding to a size of the target image.

17. The electronic device of claim 10, wherein the target model includes a first target model and a second target model, the first target model is configured to perform feature transformation on a relative positional relationship between the target image and the reference image to obtain reference coded data of the reference image, and the second target model is configured to perform an iterative image expansion process k times on coded data of the target image according to the reference coded data to obtain target coded data.

18. The electronic device of claim 10, wherein generating the display image includes:
decoding the reference image to obtain a compressed reference image;
according to a relative positional relationship between the target image and the reference image, processing the compressed reference image to obtain a compressed display image; and
enlarging a resolution of the compressed display image to a target resolution to obtain the display image.

19. An image processing method, comprising:
in response to a photo capture instruction, obtaining a target image and a corresponding reference image, wherein the target image and the reference images include a same object, the target image is captured from a same location as that of the reference image and at a same orientation as that of the reference image, and the target image has a smaller field of view than that of the reference image;
storing the reference image and the target image; and
displaying the target image, wherein the reference image is used for generating a display image together with the target image based on a target model in response to an expansion instruction directed at the target image, the size of the display image is larger than that of the target image, and the display image comprises image content and expanded content of the target image.

20. An electronic device comprising:
a display screen for displaying images;
one or more processors including:
a first acquisition module for obtaining a target image;
a second acquisition module configured to obtain a reference image, wherein the target image and the reference images include a same object, the target image is captured from a same location as that of the reference image, the target image is captured at a same orientation as that of the reference image, and the target image has a smaller field of view than that of the reference image; and
a generation module for generating a display image based on a target model, the reference image, and the target image,
wherein the size of the display image is larger than that of the target image, the display image comprises image content of the target image and expanded content, and the expanded content is generated based on the target model, the reference image and the target image and used for expanding the display content of at least one direction of the target image;
and the display screen displays the target image.
